(19) United States
(12) Patent Application Publication
(10) Pub. No.: US 2020/0149985 A1
(43) Pub. Date: May 14, 2020

(54) MULTIPLE SENSOR FALSE POSITIVE DETECTION

(71) Applicant: Prevent Biometrics, Inc., Edina, MN (US)

(72) Inventors: Adam Bartsch, Chaska, MN (US); Mike Shogren, Minneapolis, MN (US)

(21) Appl. No.: 16/682,767

(22) Filed: Nov. 13, 2019

Related U.S. Application Data
(63) Continuation of application No. 62/760,117, filed on Nov. 13, 2018.

(51) Int. Cl. G01L 5/00; G01P 3/12

(52) U.S. Cl. CPC G01L 5/0052; G01P 3/12

(57) ABSTRACT

A system for sensing impacts may include a first sensing system configured for placement on a user and to sense inertial motion and establish a first sensor result, a second sensing system configured to sense inertial motion and establish a second sensor result, and a processor for comparing the first sensor result to the second sensor result to assess whether the first and second sensor results are indicative of a same impact.

### CROSS-REFERENCE TO RELATED APPLICATIONS

The present application claims priority to U.S. Provisional Application No. 62/760,117 filed on Nov. 13, 2018 entitled Multiple Device False Positive Detection, the content of which is hereby incorporated be reference in its entirety.

### FIELD OF THE INVENTION

The present disclosure relates to systems for sensing impact-related motion. More particularly, the present disclosure relates to systems for sensing head or related motion that may have implications relating to slight, ongoing, and/or severe brain injury. Still more particularly, the present disclosure relates to systems for sensing inertial motion and isolating relevant inertial motion from irrelevant inertial motion and analyzing relevant inertial motion for impacts.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Sensing head impacts for purposes of assessing risk of brain damage has come to the forefront in many activities. Sensor systems on helmets, on skin patches, on mouth guards, or on other systems or devices have been studied and implemented. Several difficulties exist with respect to obtaining accurate and precise results. For example, helmets are designed to reduce and/or distribute impact loads to the head via a relatively loose helmet-to-head coupling, so sensors on the helmet may sense impacts that are higher or otherwise different than those that are passed onto the head and the direction and/or magnitude of the impact on the helmet may create uncertainty as to the forces experienced by the head. One particular difficulty with respect to obtaining accurate and precise results across many systems relates to false positives. For example, impacts may be sensed by equipment when a user drops the equipment or drops or sets down a bag that the equipment is in. Still other impacts may be sensed when a bag is being carried and swings against an obstruction. These and other impacts that may be sensed by an impact sensor are not relevant to head impacts and are preferably screened out of the data that is collected and more seriously assessed.

Some preliminary efforts to rule out false positives for mouthguard-based systems have focused on assuring that the mouth guard is in on the teeth. For example, a proximity sensor has been suggested as a method for determining when the mouthguard is on the teeth. However, when not in use, users have been known to turn the mouthguard sideways and chew on it, which may trigger the proximity sensor(s) and result in false positive readings. Also, a user may put a finger, lip, or article of clothing in front of the sensor causing the system to believe, so to speak, that it is on the teeth. Simple on/off switches have also been suggested, but may only be helpful to the extent the device is turned off when not being actively used during situations where impact results are desired. (i.e., during a game when the player is not on the field and has his/her helmet off or mouthguard out of the mouth). Counting on users to constantly activate and deactivate sensors is not reliable.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, a system for sensing impacts may include a first sensing system configured for placement on a user and to sense inertial motion and establish a first sensor result. The system may also include a second sensing system configured to sense inertial motion and establish a second sensor result. The system may also include a processor for comparing the first sensor result to the second sensor result to assess whether the first and second sensor results are indicative of a same impact.

In one or more embodiments, a method for ruling out false positives may include receiving a first sensor result from a first sensing device configured for placement on a user, receiving a second sensor result from a second sensing device, and comparing the first sensor result to the second sensor result. The method may also include assessing whether the first and second sensor results are indicative of a same impact.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a perspective view of a multiple sensor system for sensing inertial motion and ruling out false positive data, according to one or more embodiments.

FIG. 2 is a perspective view of another multiple sensor system for sensing inertial motion and ruling out false positive data, according to one or more embodiments.

FIG. 3 is a perspective view of another multiple sensor system for sensing inertial motion and ruling out false positive data, according to one or more embodiments.

FIG. 4 is a perspective view of another multiple sensor system for sensing inertial motion and ruling out false positive data, according to one or more embodiments.

FIG. 5 is a diagram of a method of ruling out false positive inertial motion results, according to one or more embodiments.

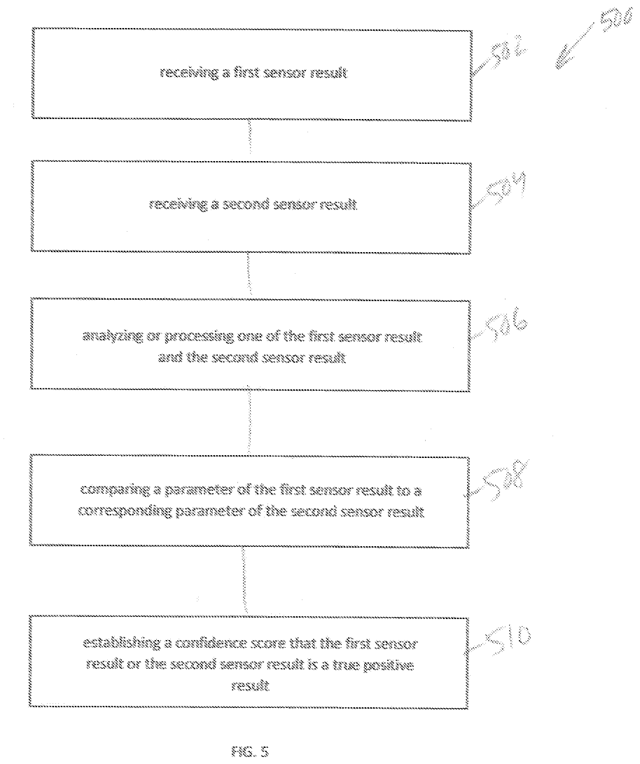

### DETAILED DESCRIPTION

The present application, in one or more embodiments, includes multiple sensors each configured for sensing inertial motion of a user. The multiple sensors may each be part of a device configured for protecting a particular portion of the body in addition to having sensing capabilities and may take the form of a helmet or a mouthguard, for example. In other cases, one or more of the sensor devices may be dedicated to sensing impact without necessarily providing protection, such as a patch, for example. Another example may include a body-worn system attached to the user's thorax, for example. Another example may include a video-based sensor system configured for co-locating potential impacts via cameras placed at known locations around a playing field. The sensors may be part of a same device or part of separate devices. In one or more embodiments, the devices may be commonly or almost always used with one or more of the other devices during activities where relevant inertial motion is expected. Moreover, the devices may also be unlikely to experience the same inertial motion when not in use during those activities. As such, during the activities the devices should sense the same inertial motions and outside of those activities, the devices may have a low likelihood of sensing the same inertial motion. Where one of the sensors senses an inertial motion and another sensor simultaneously senses an inertial motion, the probability that the sensed inertial motion is a false positive may be very low. Rather, it is likely that simultaneously sensed inertial motions, or near-simultaneously sensed inertial motions, relate to the same inertial motion of the user and that the motion is a relevant motion that occurred during the activity. In addition, where first and second sensors sense an inertial motion that is the same, the probability that the sensed inertial motion is a false positive may, again, be very low.

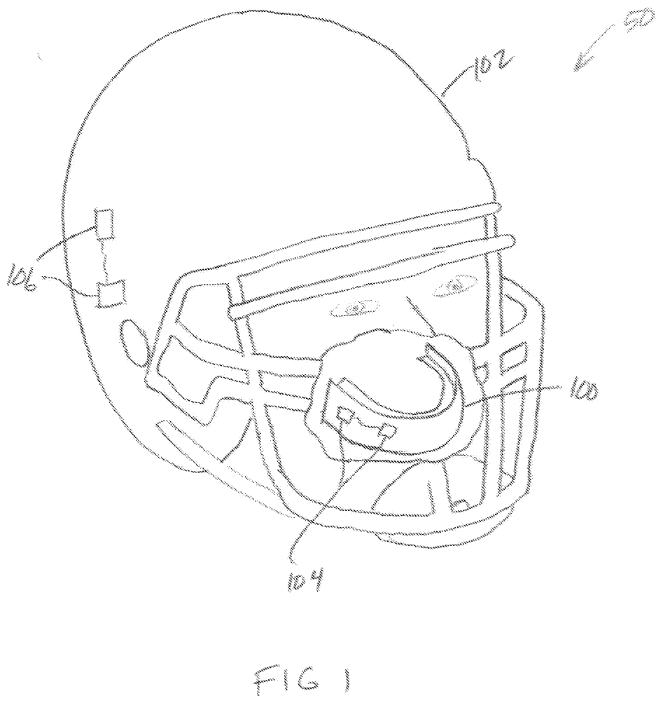

FIG. 1 shows a multi-sensor system 50, according to one or more embodiments. For example, as shown, the system may include a mouthguard-based sensing device 100 and a helmet-based sensing device 102. As mentioned, the sensors may be part of protective devices such as mouthguards, helmets, or other injury prevention devices. In one or more embodiments, the sensors or sensing systems may be a first sensing system 104 with one or more sensors and a second sensing system 106 with one or more sensors. The sensors may be part of devices that are likely or commonly worn or used together when participating in an activity, such as a military activity of training for firearms, combatives, parachuting or the like, as well as a sporting activity like football, hockey, soccer, lacrosse, or other sports. The sensing systems 104/106 may also include power supplies and processors and/or storage means for storing the sensor results. Communication means may also be provided such as Bluetooth or other short range communication or Wi-Fi or cellular communication technologies. Still other communication technologies may be provided.

The multi-sensor system 50 may be configured for sensing inertial motion of a user and analyzing and/or communicating the results of those impacts. For example, each of the sensing systems 104/106 may be the same or similar to those that are shown and described in U.S. Pat. Nos. 9,044,198, 9,149,227, 9,289,176, and 9,585,619, the contents of which are incorporated by reference herein in their entireties. Still other sensing systems and process may be used, such as those described in U.S. Pat. Nos. 8,537,017, 8,466,794, 9,526,289, 8,554,495, and 9,554,607, the contents of which are incorporated by reference herein in their entireties. Still other sensing systems and processes may be used, such as those described in U.S. patent application Ser. Nos. 13/009,580, 14/040,157, and 14/040,111, the contents of which are incorporated by reference herein in their entireties.

In one or more embodiments, the first and second sensing systems 104/106 may be configured to sense inertial motion of a user and establish first and second sensor results, respectively, such that the results can be compared in an effort to rule out false positive results. The first and second systems 104/106 may be configured for placement on a user simultaneously with each other or other devices. The first and second sensing systems may be configured to communicate the sensor results to one or the other of the sensor systems or to a central processing station or system. A processor on or with one of the sensor systems or the central processing station may be configured to compare the first sensor result with the second sensor result to assess whether the first and second sensor results are indicative of a same inertial motion. In one or more embodiments, one of the sensor systems may be on a device that has more space available, such as a helmet compared to a mouthguard. In one or more embodiments, one of the sensor systems may function as a hub or master, so to speak, and may receive information from the other sensor system and the hub or master may be responsible for higher power processing, communicating longer distances, and/or communicating more information, for example.

In one embodiment, a comparison of the sensor system results may not involve comparing the nature of the results. For example, in one or more embodiments, the timing of the results may be relevant. That is, the first and second sensing systems may include a time stamp or other indication of time with the sensor results such that the absolute or relative time of the sensed inertial motion may be stored. One of the systems 104/106 or a central processing station may be configured for comparing the sensor results from each of the sensors to determine if the sensors were sensing the same inertial motion and, thus, likely reflect a true positive data point or data set or whether the results are, instead, spurious inertial data. For example, the processor may be configured to compare a first time stamp of the first sensor result to a second time stamp of the second sensor result and to label the sensor results true positive results when the first time stamp and the second time stamp indicate simultaneous or near-simultaneous sensed inertial motion. In one or more embodiments, the first and/or second time stamp may be compared to each other when being used during play, practice, or a game, for example. That is, time ranges of play, practice, or games may be used to reduce or eliminate readings outside of those ranges, which may be inherently irrelevant.

Additionally or alternatively, a same inertial motion may be determined by comparing the nature of the sensed inertial motion to see how similar the sensed inertial motions are. For example, the processor may be configured to analyze the first sensor result and the second sensor result to establish a resulting first inertial motion and a resulting second inertial motion. This analysis may include translating one or both sensor results to a common point. For example, each sensor result may be translated to the center of gravity of the head or another useful point of reference such as a point on the head, skull, or brain, for example. In other embodiments, the sensor results may be translated to the known location of the other sensor such that only one of the sensor results is translated and the other is unchanged. In either case, data defining the position and orientation, or the intended position and orientation, of the sensing system on the body may be used to perform the translation. Translation of the data may be performed based on one or more of the translation algorithms outlined in the above-referenced patents and/or applications.

After translating the results to a common point, the results may be compared. The comparison may involve comparing selected parameters of the first and second resulting inertial motions. Parameters that may be compared may include linear and rotational magnitude, frequency, phase, force, moment, momentum, energy, direction, jerk, acceleration, rotation, velocity, and/or displacement. Other parameters may also be used and, as mentioned above, parameters that do not require translation for comparison may also be used.

Where translated inertial motion from separate sensors results in a same or similar parameter or group of parameters of an inertial motion, the probability that the sensors sensed the same inertial motion may be very high and may, thus, be indicative of a true positive result. In one or more embodiments a combination of time comparisons and parameters of inertial motion comparisons may be used. In one or more embodiments, each sensor may calculate and report a probability or confidence score that the impact is a true positive. The probabilities or confidence scores from the individual sensors may be compared, summed, multiplied, or otherwise combined in various ways to determine an overall probability or confidence score that a true positive impact occurred. That is, the use of multiple sensing systems to help identify true positive data and rule out false positive data may include pre-determining whether the data appears to be true positive based on each sensor's data. The process may then include working with the likelihood information. Alternatively or additionally, the process may include post-determination of the likelihood of true positive data by using data from both sensor systems to determine a likelihood of a true positive impact. That is, the sensor data from the several sensors may be used together to calculate a probability or confidence score that the impact is a true positive impact.

It is to be appreciated that the sensing systems may be adapted to sense inertial motion in a similar or different fashion (e.g., when compared to each other) and the sensors may be adapted for sensing relevant information based on the system or mechanism of which they are a part. For example, a sensing system on a helmet may be a pressure sensing system. That is, the system may be adapted for sensing pressure changes between the helmet padding and the scalp or other portion of the head. In contrast, a mouthguard sensing system may be a kinematic sensing system adapted for sensing accelerations, forces, displacement, velocities or other relevant kinematic parameters. In other embodiments, additionally or alternatively, the helmet system may be equipped with kinematic sensing capabilities and the mouthguard may be equipped with pressure sensing capabilities. Still other forms of sensing may be provided. Moreover, the processor may be equipped with time monitoring systems and the time monitoring systems of the sensing systems may be synchronized to allow for comparing time stamps or time trace information. Accordingly, where parameter comparison is being performed, the analysis prior to comparison may involve deriving or calculating common parameters for comparison from the sensed data.

It is to be appreciated that the first and second sensors may take many different forms and be arranged in many different devices. In one or more embodiments, the devices may be commonly worn together during an activity and unlikely to experience the same inertial motions when not in use. For example, as shown in FIG. 1, the system may include first and second sensing systems each arranged in one of a mouthguard or a helmet. In one or more embodiments, the devices may include a combination of two or more of a helmet, a mouthguard, a patch, or other device or system.

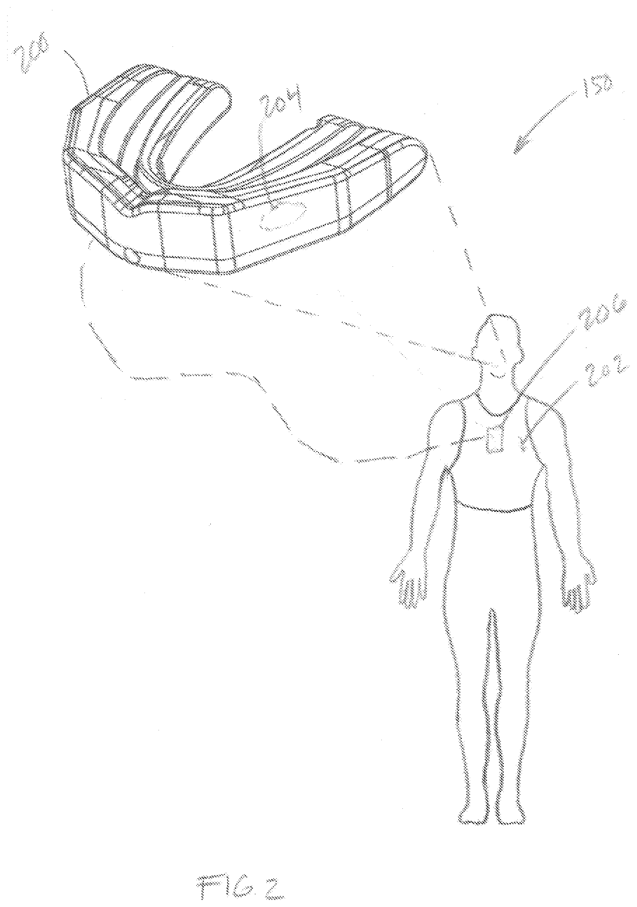

With reference to FIG. 2, a sensing system 150 may include a first sensing system 204 arranged on or within a mouthguard 200, while a second sensing system 206 may be arranged on or within an article of clothing or wearable 202 surrounding a user's thorax. For example, a bra or “bro” may be provided with a sensing system 206 embedded therein or attachable thereto. In one or more embodiments, the sensing system 206 may be part of a separate attachable and/or detachable device to the clothing or wearable.

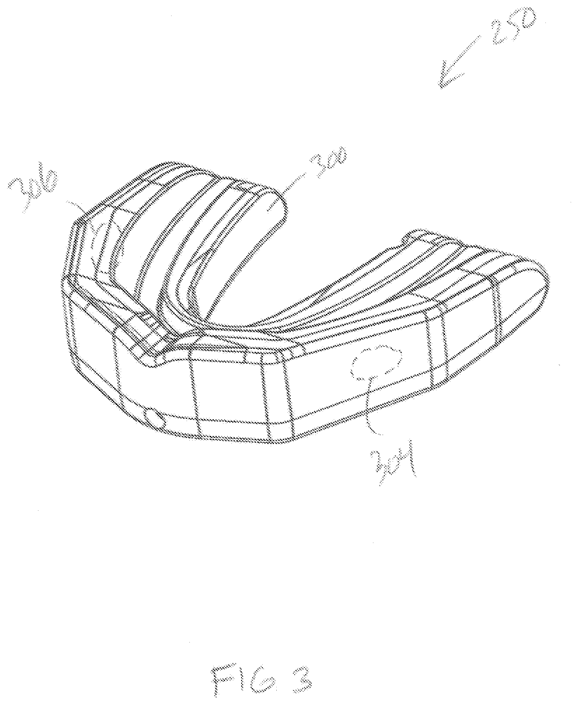

With reference to FIG. 3, the first and second sensor systems 304/306 of a sensing system 250 may be part of a single device 300 such as a mouthguard. In one or more embodiments, this may take the form of a two piece mouthguard such that the reference frames of each piece are aligned or known when the device is in use, but unaligned or unknown when the device is not in use. For example, the two piece mouthguard may include a storage case where one half of the mouthguard is stored in an inverted position relative to the other half of the mouthguard such that forces experienced by the mouthguard pieces during storage are opposite along at least one axis when not being worn. Still other devices may be used and other measures may be taken to simplify the identification of false positives. For example, a single piece mouth guard with a flexible joint between the two halves may be used. In this embodiment, the comparison of the sensed impact may relate to comparing a particular force or acceleration along an axis that is expected to be a common axis when the mouthguard is being worn properly. For example, if a horizontal axis experiences a first acceleration on a sensor on one side of the mouth and a second acceleration on a sensor on an opposite side of the mouth, these accelerations may be expected to be the same or similar if the mouthguard is being worn properly and the horizontal axis of the two sensors is generally on the same plane.

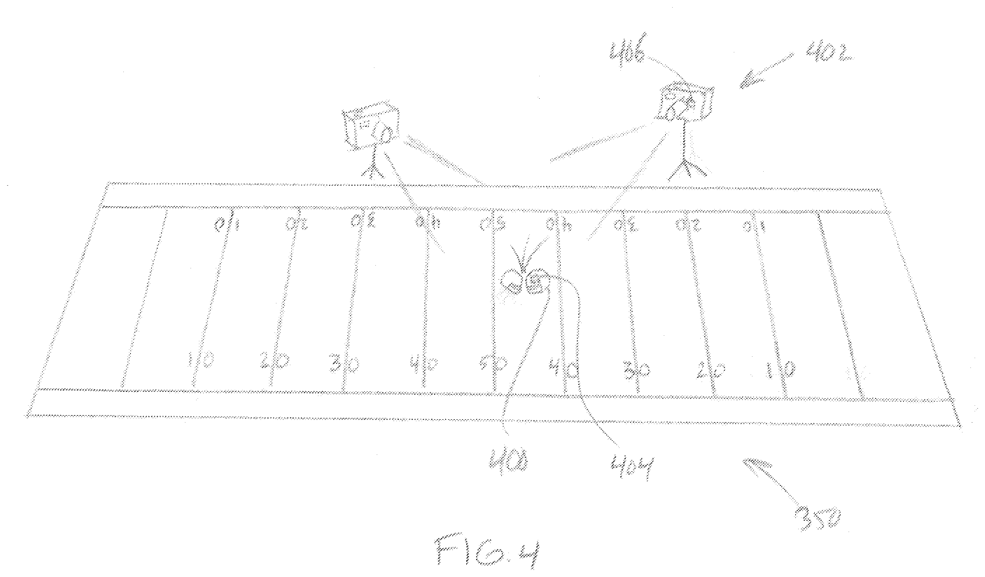

In still another embodiment, a system 350 may be provided where a first sensing system is present on the user and the other sensing system is remote from the user. For example, as shown in FIG. 4, a sensing system 402 in a helmet, mouthguard, bra, bro, or other wearable device 400 may be present on a user and may be adapted to sense inertial motion such as impacts during a football game. A second sensing system 406 may be part of an imaging tool such as a camera, video camera, or other footage capturing tool 402. The sensing system 406 may be adapted to identify inertial motion of a user based on changes in direction, speed, acceleration, velocity, etc. In one or more embodiments, the second sensing system 406 may track a particular player and sense when inertial motions occur. In other embodiments, the second sensing system 406 may monitor an area and identify coordinates and timing of inertial motion. In either case, the data from the second sensing system 406 may be compared to the data from a mouthguard or other sensing system 404 on the user to determine if the sensed data is true positive data. For example, if the second sensing system 406 senses an impact at the same time as the first sensing system 404 and the second sensing system 406 was tracking the player with the first sensing system 404, a true positive impact may be likely. As another example, if the second sensing system 406 senses an impact at a particular location and the first sensing system 404 senses an impact and is located at the location sensed by the second sensing system 406, a true positive impact may be likely.

In one or more embodiments, a method 500 for ruling out false positives may include receiving a first sensor result (502) from a first sensing device configured for placement on a user. The method may also include receiving a second sensor result (504) from a second sensing device configured for placement on a user with the first device. The method may include comparing the first sensor result to the second sensor result and assessing whether the first and second sensor results are indicative of a same impact (508). The method may include comparing a first time stamp of the first sensor result to a second time stamp of the second sensor result. The method may include assessing the impacts by labeling the sensor results true positive results when the first time stamp and the second time stamp indicate simultaneous impact. The method may include analyzing the first sensor result and the second sensor result to establish a resulting first head impact and a resulting second head impact (506). The method may also include each sensor calculating and reporting a probability or confidence score that the impact is a true positive. (510) In one or more embodiments, this may involve analyzing each sensor's individual data and use mathematical algorithms to characterize the quality of the collected signals and generate a score. The score may indicate the likelihood of the data being a true positive. The two sensors' results may be compared to previously verified true positives from a known source (e.g., a lab, or on-filed video verification). An empirical relationship may be provided (e.g., Sensor 1 score=XYZ and Sensor 2 score=ABC) and flag each as true positive. However, if Sensor 1 score=XY and Sensor 2 score=AC, then it may be flagged as false positive. As such, in one or more embodiments, the system may rely on a single sensor's confidence score to determine whether sensed inertial motion was true positive. However, leveraging a second sensor's confidence score may add further assurance of a true positive inertial motion or impact. Still further, further confirmation using time synchronicity gives even further assurance of a true positive result. The probabilities or confidence scores may be compared, summed, multiplied or combined in various ways to determine an overall probability or confidence score that a true positive impact occurred. As mentioned, the method may also include comparing raw time trace data from each of the sensors, in their local and/or transformed coordinate frames such as at the head center of gravity or any other desired point on the skull, brain, or head, or combining raw time trace data from each of the sensors to create aggregate time trace(s) for analysis of true positive probability. The time traces may share common features that indicate higher likelihood of true positive impacts. The time traces may also be combined into an aggregate time trace that can be analyzed on its own or in conjunction with the individual sensor time traces to determine the likelihood of true positive. The linear and rotational magnitude, frequency, phase, force, moment, momentum, energy, direction, jerk, acceleration, rotation, velocity, and/or displacement, or probability of true positive impact may be determined from the aggregate time traces or from the individual time traces. The method may also include comparing selected parameters of the first and second resulting head impacts such as linear and rotational magnitude, frequency, phase, force, moment, momentum, energy, direction, jerk, acceleration, rotation, velocity, and/or displacement. Such, magnitude, direction, and rotation may be accelerations, velocities, forces, torques, or other values. Comparing the linear and rotational magnitude, frequency, phase, force, moment, momentum, energy, direction, jerk, acceleration, rotation, velocity, and/or displacement may allow for simultaneously sensed impacts to be labeled as false positive when, for example, the impact stems from impacts occurring when the first and second devices are in a gym bag and the impacts on each device differ due to their different and flexible locations within the bag, which are likely different than their relative positions when the devices are being worn or used. In other situations, the impacts, while appearing simultaneous may be analyzed to determine a head displacement. Where the displacements are not in the same direction, for example, the impact may be unlikely to be a true positive result. In some embodiments, this displacement may be in the wrong direction based on a single sensor result or the displacement from the multiple sensors may result in differing displacement results, which may suggest the impacts were not the same or otherwise are nonsensical. In some embodiments, for example, where a user may chew on a mouthguard, the analysis resulting from such an activity may have displacements that are inconsistent with the sensed forces.

In one or more embodiments, concepts of co-registration may be used with respect to the two sensing devices to help rule out false positives. For example, the two sensing devices may be placed in relatively fixed and ascertainable positions when the devices are being worn. In contrast, the relative position of the devices may be very flexible when the devices are not being worn. With knowledge of the expected relative position and orientation of the sensors on the multiple devices when the devices are each being worn, the sensor results may be analyzed relatively quickly to determine if proper relative positions exist. For example, an impact to the head of a user may cause relative accelerations along respective axes of the sensors on each of the devices and a relatively quick comparison of an expected ratio between selected axes of the sensors may allow for quickly determining if the sensors are in the expected or suitable position on the user.

While a system primarily of two sensing devices has been described, one, two, three, or any other number of sensing systems may be used. The several devices may be placed in communication with one of the other sensing systems, with each other, and/or with another processing system for purposes of assessing whether a inertial motion data is true positive data based on one or more of the sensing devices' information.

In one or more embodiments, one or more other body-worn sensors may be used and/or relied on to support the identification of true positives. For example, other sensors that may not be focused on sensing inertial motion may capture data that may be relevant for purposes of identifying true positive impacts. In one or more embodiments, other sensors such as heart rate monitors, thorax mounted devices, activity trackers, or other body-worn sensors may be used. The data may be associated with a time stamp or a time trace and, as such, may be compared with the inertial motion data on a time wise basis to help in identifying true positive impacts. In one or more embodiments, for example, changes in heart rate may occur at an impact or shortly thereafter, for example, when a user stops, slows down, or otherwise makes a change in their activity level. Still other types of data may be helpful in association with inertial motion data to identify the data as true positive data.

Another example of non-inertial sensing data, and as discussed with respect to FIG. 4, non-body worn sensors from video review, image photogrammetry, image processing and artificial intelligence/machine learning algorithms that know player position/location on a field may capture data. The video information may be synchronized with the impact or other data and may be helpful to assessing whether a sensed impact was a true positive impact. That is, for example, high speed cameras or normal speed cameras with time stamps or time traces or artificial intelligence/machine learning algorithms may be used to look for changes in direction, abrupt changes in motion, or other video-based parameters that may indicate that an impact has occurred. The synchronous video data may be used as yet another way of assessing the probability or likelihood of a true positive impact.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A system for sensing impacts, comprising:
a first sensing system configured for placement on a user and to sense inertial motion and establish a first sensor result;
a second sensing system configured to sense inertial motion and establish a second sensor result; and
a processor for comparing the first sensor result to the second sensor result to assess whether the first and second sensor results are indicative of a same impact.

2. The system of claim 1, wherein the processor is configured to compare a first time stamp of the first sensor result to a second time stamp of the second sensor result.

3. The system of claim 2, wherein the processor is configured to label the sensor results true positive results when the first time stamp and the second time stamp indicate simultaneous or near-simultaneous impact.

4. The system of claim 1, wherein the processor is configured to analyze at least one of the first sensor result and the second sensor result to establish comparable results each defining inertial motion at a common point.

5. The system of claim 4, wherein comparing comprises comparing selected parameters of the respective comparable results.

6. The system of claim 5, wherein the selected parameters include linear or rotational parameters.

7. The system of claim 5, wherein the selected parameters include force.

8. The system of claim 5, wherein the selected parameters include energy.

9. The system of claim 5, wherein the selected parameters include calculated probability that the impact is a true positive.

10. The system of one of claim 6, wherein the magnitude is the magnitude of an acceleration, a velocity, a force, or a torque.

11. The system of claim 1, wherein the processor is co-located with the first or the second sensing device.

12. The system of claim 1, wherein the processor is a separate device such as a smartphone, tablet, or personal computer.

13. The system of claim 1, wherein the first sensing system and the second sensing system are each part of a separate device.

14. The system of claim 1, wherein the first sensing system and the second sensing system are part of a single device.

15. A method for ruling out false positives, comprising:
receiving a first sensor result from a first sensing device configured for placement on a user;
receiving a second sensor result from a second sensing device;
comparing the first sensor result to the second sensor result; and
assessing whether the first and second sensor results are indicative of a same impact.

16. The method of claim 15, wherein comparing comprises a comparing a first time stamp of the first sensor result to a second time stamp of the second sensor result.

17. The method of claim 16, wherein assessing comprises labeling the sensor results true positive results when the first time stamp and the second time stamp indicate simultaneous impact.

18. The method of claim 17, further comprising analyzing the first sensor result and the second sensor result to establish a resulting first head impact and a resulting second head impact.

19. The method of claim 18, wherein comparing comprises comparing selected parameters of the resulting first and second head impacts.

20. The method of claim 19, wherein the selected parameters include linear or rotational parameters.

21. The method of claim 19, wherein the selected parameters include force.

22. The method of claim 19, wherein the selected parameters include energy.

23. The method of claim 19, wherein the selected parameters include calculated probability that the impact is true positive.

24. The system of one of claim 20, wherein the magnitude is the magnitude of an acceleration, a velocity, a force, or a torque.
